(19) United States
(12) Patent Application Publication
(10) Pub. No.: US 2018/0266896 A1
(43) Pub. Date: Sep. 20, 2018

(54) TEMPERATURE MANAGEMENT APPARATUS, TEMPERATURE MANAGEMENT METHOD AND NON-TRANSITORY COMPUTER READABLE MEDIUM

(71) Applicant: HITACHI HIGH-TECHNOLOGIES CORPORATION, Tokyo (JP)

(72) Inventors: Takashi SAEKI, Tokyo (JP); Toru TANABE, Tokyo (JP)

(21) Appl. No.: 15/468,250

(22) Filed: Mar. 24, 2017

(30) Foreign Application Priority Data
Mar. 15, 2017 (JP) 2017-050527

(51) Int. Cl. G01K 11/12; G01K 13/00; F25D 29/00

(52) U.S. Cl. CPC G01K 11/12; F25D 2700/16; F25D 29/006; G01K 13/00

(57) ABSTRACT

A temperature management apparatus comprising: an acquiring unit to acquire an image containing a portion coated with a first thermo-paint with its color changing based on a first cumulative temperature as a product of a temperature difference between a predetermined first temperature and an ambient temperature when the ambient temperature exceeds the first temperature and time for which the ambient temperature exceeds the first temperature; a storage unit to store first data exhibiting a correspondence relationship between the color of the first thermo-paint and the first cumulative temperature; and an arithmetic unit to compute the first cumulative temperature corresponding to the color of the first thermo-paint, based on the color of the first thermo-paint contained in the image and the first data, wherein the first thermo-paint is coated directly or indirectly over a measurement object.

### CROSS-REFERENCE TO RELATED APPLICATION

This application is based upon and claims the benefit of priority of the prior Japanese Patent Application No. 2017-050527 filed on Mar. 15, 2017, the entire contents of which are incorporated herein by reference.

### TECHNICAL FIELD

The present invention pertains to a temperature management apparatus, a temperature management method, and a temperature management program.

### BACKGROUND ART

There is increasingly importance of managing qualities of foods due to amendments of Food Safety Modernization Act (FSMA) of U.S.A. Temperature management is one of items of the food quality management.

### DOCUMENTS OF PRIOR ARTS

### Patent Documents

[Patent Document 1] Japanese Patent Application Laid-Open Publication No. 2016-180577

### SUMMARY OF THE INVENTION

It is considered that temperature loggers are installed at all of quality management target commodities in order to manage temperatures of commodities instanced by foods. It is not, however, realistic that the temperature loggers are installed at the ordinary commodities because of requiring costs for installing the temperature loggers at all of the commodities.

It is also considered that the temperature is managed by installing the temperature loggers in a shipping container and a warehouse containing the commodities, and temperatures in the shipping container and the warehouse are not necessarily uniform but are different from the temperatures of the commodities as the case may be.

It is an object of the present invention to simply manage temperatures of individual commodities.

The following means are adopted for solving the problems described above.

Specifically, according to a first aspect, a temperature management apparatus includes: an acquiring unit to acquire an image containing a portion coated with a first thermo-paint with its color changing based on a first cumulative temperature as a product of a temperature difference between a predetermined first temperature and an ambient temperature when the ambient temperature exceeds the first temperature and time for which the ambient temperature exceeds the first temperature; a storage unit to store first data exhibiting a correspondence relationship between the color of the first thermo-paint and the first cumulative temperature; and an arithmetic unit to compute the first cumulative temperature corresponding to the color of the first thermo-paint, based on the color of the first thermo-paint contained in the image and the first data, in which the first thermo-paint is coated directly or indirectly over a measurement object.

The aspect of the disclosure may be attained such that an information processing apparatus runs a program. To be specific, the configuration of the disclosure can be specified by way of a program to make the information processing apparatus execute processes to be executed by respective means according to the aspect described above, or by way of a non-transitory computer readable recording medium recorded with this program. The configuration of the disclosure may also be specified as a method by which the information processing apparatus executes the processes to be executed by the respective means described above. The configuration of the disclosure may further be specified as a system including the information processing apparatus that executes the processes to be executed by the respective means described above.

Steps of writing the program include, as a matter of course, processes to be executed in time-series along a described sequence, and also processes that are not necessarily executed in time-series but are executed in parallel or individually. Part of the steps of writing the program may be omitted.

According to the present invention, the temperatures of the individual commodities can be simply managed.

### BRIEF DESCRIPTION OF THE DRAWINGS

FIG. 1 is a diagram illustrating an example of a configuration of a temperature management system according to an embodiment.

FIG. 2 is a graphic chart illustrating an example 1 of a correspondence relationship between a color and a cumulative temperature of a thermo-paint.

FIG. 3 is a graphic chart illustrating an example 2 of the correspondence relationship between the color and the cumulative temperature of the thermo-paint.

FIG. 4 is a graphic chart illustrating an example of the cumulative temperature.

FIG. 5 is a diagram illustrating an example of a hardware configuration of a computer.

FIG. 6 is a flowchart illustrating an example of an operation flow of a temperature management system according to the embodiment.

FIG. 7 is a graphic chart illustrating an example of the cumulative temperature.

FIG. 8 is a diagram illustrating an example of a management index table.

FIG. 9 is a diagram illustrating an output example of an output unit 140.

### DESCRIPTION OF EMBODIMENTS

An embodiment will hereinafter be described with reference to the drawings. A configuration of the embodiment is an exemplification, and a configuration of the invention is not limited to the specific configuration of the embodiment of the disclosure. A specific configuration corresponding to the embodiment may be adopted when carrying out the invention.

### Example of Configuration

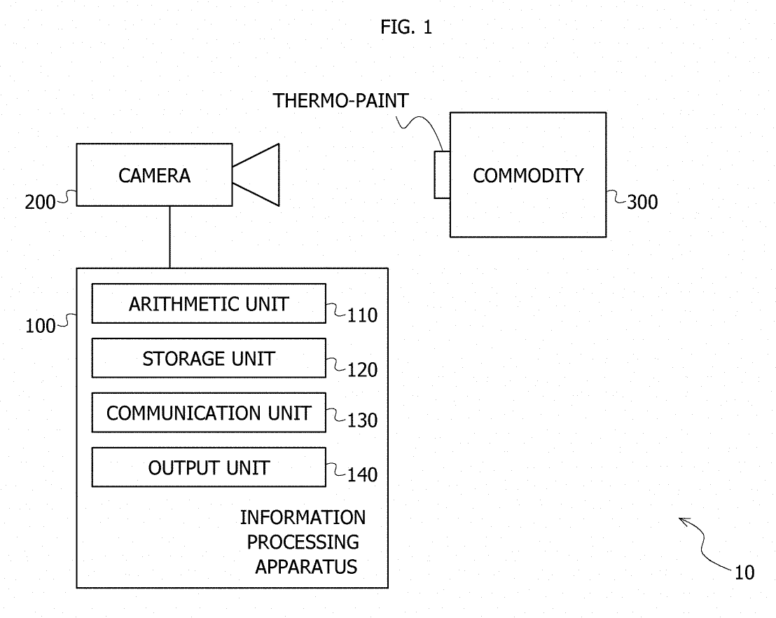

FIG. 1 is a diagram illustrating an example of a configuration of a temperature management system according to the embodiment. A temperature management system 10 in FIG. 1 includes an information processing apparatus 100, a camera 200, and a commodity 300. The information processing apparatus 100 includes an arithmetic unit 110, a storage unit 120, and a communication unit 130. A thermo-paint (a paint indicating a temperature) is coated directly over a surface of the temperature management target commodity 300 or indirectly over a surface of a card, a seal and other equivalent materials attached to a package (a packing film, a sheet of packing paper and other equivalent packages), a packing bag and a packing box of the commodity 300. These packages and other equivalent materials will hereinafter be simply termed the package. The information processing apparatus 100 is one example of “a temperature management apparatus”. The commodity 300 is one example of “a measurement object”. The information processing apparatus 100 may be connected to other information processing apparatuses instanced by a server via a network and other equivalent communication infrastructures.

The thermo-paint used herein is a paint, of which a color changes corresponding to a product of a temperature difference (ΔT) between a predetermined reference temperature and a temperature of the thermo-paint (an ambient temperature of this paint), and time with ΔT being positive. Herein, this product is referred to as a cumulative temperature. The color with respect to the reference temperature and the cumulative temperature can be controlled by a substance used as the thermo-paint. The thermo-paint changes unidirectionally from, e.g., a white color to a blue color corresponding to the cumulative temperature. The color change of the thermo-paint is not limited to this pattern. The color and the cumulative temperature of the thermo-paint have a one-to-one correspondence till reaching a predetermined cumulative temperature. The thermo-paint keeps the color even when becoming a temperature from a temperature equal to or higher than the predetermined reference temperature down to a temperature lower than the predetermined reference temperature. The thermo-paint may be reset in color under a predetermined condition. The thermo-paint may also involve using a paint, of which a color changes corresponding to a product of the temperature difference (ΔT) between the predetermined reference temperature and the temperature of the thermo-paint, and time with ΔT being negative.

Some of the commodities instanced by foods are required to be transported while being kept within a predetermined temperature range. However, deterioration in quality of the commodities instanced by the foods seldom or never occurs even when temporarily deviating from the predetermined temperature range. It is considered that the deterioration in quality of the commodities instanced by the foods depends on a cumulative temperature based on a temperature difference deviating from the predetermined temperature range and deviation time.

The arithmetic unit 110 of the information processing apparatus 100 acquires, from the camera 200, an image of the thermo-paint captured by the camera 200 and other equivalent image capturing devices. The arithmetic unit 110 computes the cumulative temperature, based on the thermo-paint color contained in the acquired image. The arithmetic unit 110 acquires data specifying the correspondence relationship between the color and the cumulative temperature of the thermo-paint from the storage unit 120.

The storage unit 120 stores data, tables programs and other equivalent software components used by the information processing apparatus 100. The storage unit 120 stores data (e.g., a correspondence table, a relational expression and other equivalent data) specifying the correspondence relationship between the color and the cumulative temperature of the thermo-paint. The storage unit 120 stores the images received from the camera 200. Each image may be attached with time of capturing the image, identifying information for identifying the image, information for identifying an object coated with the thermo-paint, and other equivalent items of information. The storage unit 120 stores information of the cumulative temperature computed by the arithmetic unit 110. The correspondence relationship between the color and the cumulative temperature of the thermo-paint is previously measured.

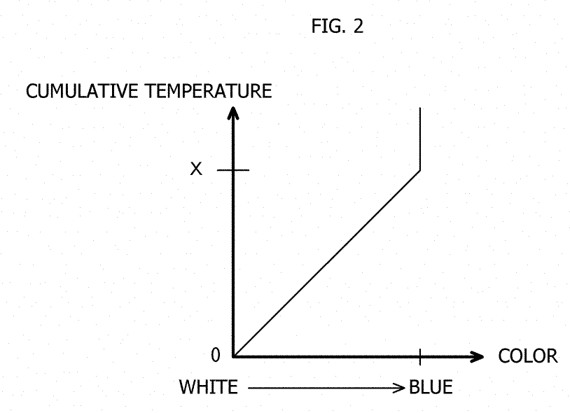

FIG. 2 is a graphic chart illustrating an example 1 of the correspondence relationship between the color and the cumulative temperature of the thermo-paint. In the graph of FIG. 2, the axis of abscissa indicates the color change of the thermo-paint, and the axis of ordinate indicates the cumulative temperature thereof. It is understood that the cumulative temperature rises gradually as the color of the thermo-paint changes from white to blue. To be a bit more specific, the thermo-paint changes from white to blue step by step as the ambient cumulative temperature of the thermo-paint gradually rises. The color of the thermo-paint, after changing to blue, does not further change even when the cumulative temperature rises. It is comprehended from the example in FIG. 2 that the cumulative temperature is equal to or higher than “X” when the color of the thermo-paint is blue. When the cumulative temperature is equal to or lower than “X”, the cumulative temperature is uniquely determined with respect to the color of the thermo-paint. In other words, the cumulative temperature is a function of the color of the thermo-paint.

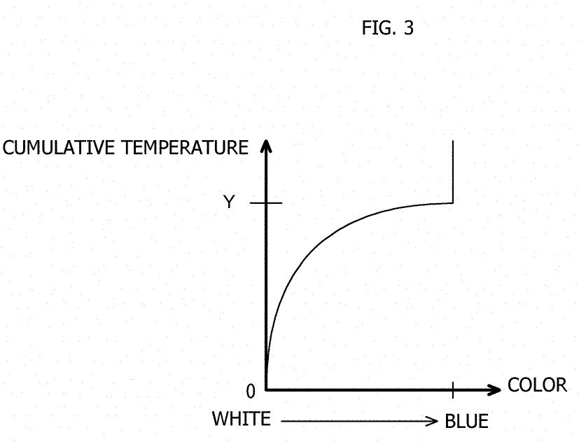

FIG. 3 is a graphic chart illustrating an example 2 of the correspondence relationship between the color and the cumulative temperature of the thermo-paint. In the graph of FIG. 3, the axis of abscissa indicates the color change of the thermo-paint, and the axis of ordinate indicates the cumulative temperature thereof. It is understood that the cumulative temperature rises abruptly as the color of the thermo-paint changes from white to blue. To be a bit more specific, when the ambient cumulative temperature of the thermo-paint rises, the thermo-paint takes on a color close to white in the beginning but abruptly changes from white to blue as the cumulative temperature increases. The color of the thermo-paint, after changing to blue, dos not change even when the cumulative temperature rises. It is comprehended from the example in FIG. 3 that the cumulative temperature is equal to or higher than “Y” when the color of the thermo-paint is blue. The cumulative temperature is uniquely determined with respect to the color of the thermo-paint when the cumulative temperature is equal to or lower than “Y”. In other words, the cumulative temperature is the function of the color of the thermo-paint. It is assumed that the thermo-paint takes on a color corresponding to a case in which the cumulative temperature is 0 when starting measurement of the cumulative temperature.

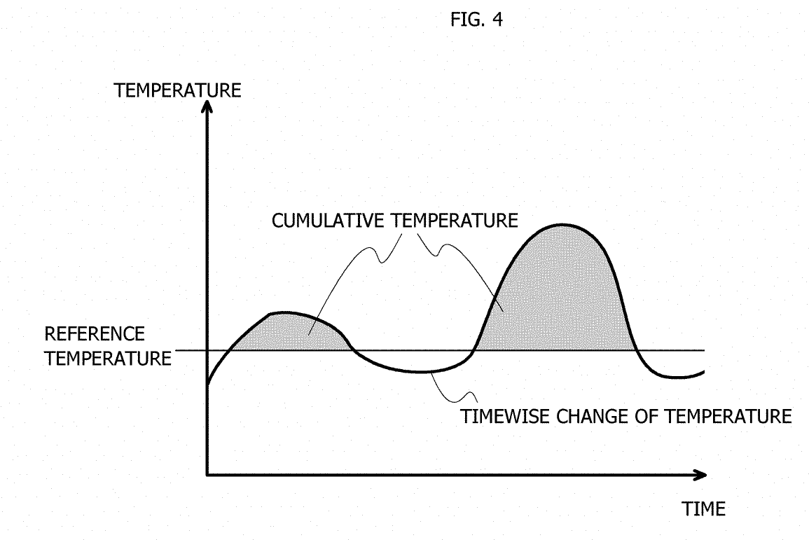

FIG. 4 is a graphic chart illustrating an example of the cumulative temperature. The graph of FIG. 4 represents an example of a timewise change of the ambient temperature of the thermo-paint. In FIG. 4, the axis of abscissa indicates the time, and the axis of ordinate indicates the temperature. A reference temperature is defined as the reference temperature of the thermo-paint. The thermo-paint changes in color when the ambient temperature is equal to or higher than the reference temperature. The color of the thermo-paint changes based on the cumulative temperature defined as the product of the temperature difference (ΔT) between the reference temperature and the ambient temperature, and the time for which the ambient temperature is equal to or higher than the reference temperature. As in FIG. 4, the cumulative temperature is defined by areas equal to or higher than the reference temperature, and by planar dimensions of the areas surrounded by a curve of the temperature change and by a straight line of the reference temperature.

The communication unit 130 transmits and receives (communicates) data and signals to and from other apparatuses via the network. The communication unit 130, which is connected to the camera 200, transmits an image capturing instruction to the camera 200, and receives, from the camera, the image captured by the camera 200. The communication unit 130 transmits the cumulative temperature computed by the arithmetic unit 110 toward other apparatuses. The communication unit 130 is one example of “an acquiring unit”.

The communication unit 130, which is connected to the server (unillustrated) via the network, may transmit the image captured by the camera 200 to this server, and the server may store the image. This image may also be stored in the server in the way of being associated with items of information about a growing district and harvesting of the commodity 300.

The output unit 140 includes a display for displaying the computed cumulative temperature and other equivalent items in the way of being directed toward the user and other equivalent persons of the information processing apparatus 100.

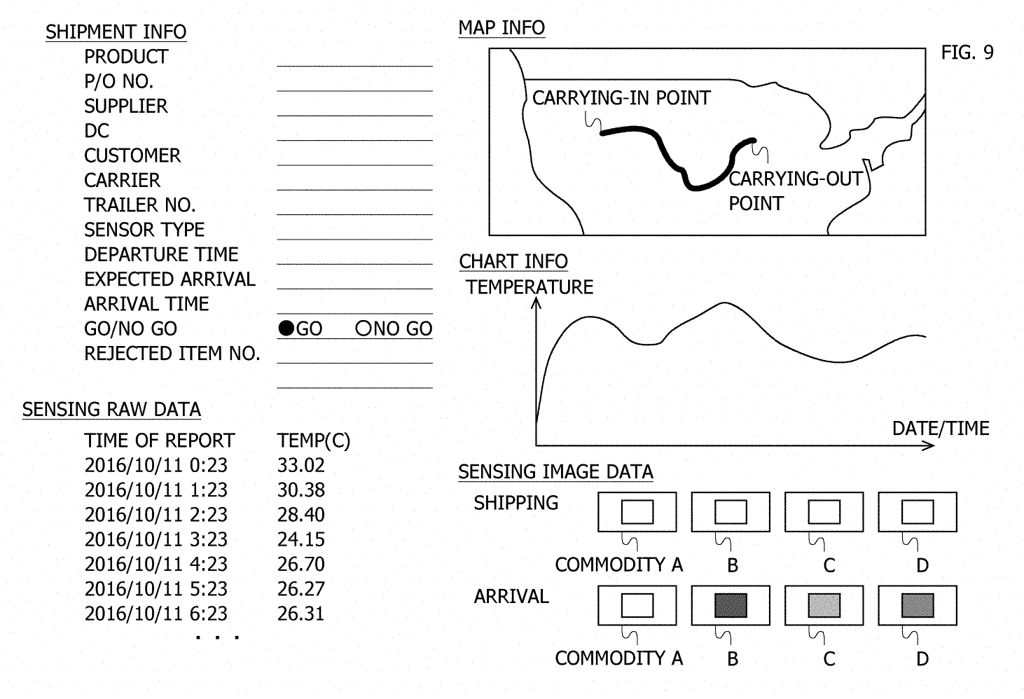

FIG. 9 is a diagram illustrating an output example of the output unit. Displayed at an upper part on a left side of the output example in FIG. 9 are customer information, a management number, carrier information, a departure date/time, an expected arrival date/time, and information (GO sign or NO GO sign) indicating whether to be receivable based on the commodity 300 being transported in a state within a setting condition range. There exists the reception-disabled commodity 300, in which case a commodity number thereof may be displayed.

Displayed at a lower part on the left side of the output example in FIG. 9 are a measurement date/time and a temperature within a transport means instanced by a transport truck storing the commodity 300 at that time. The measurement date/time is set as a fixed interval till a measurement end date/time since a measurement start date/time.

Displayed on a map at an upper part on a right side of the output example in FIG. 9 are a place to which the transport means carries the commodity 300, a place from which the transport means carries the commodity 300, and a route therebetween. Upon occurrence of abnormality, this map display enables the system to specify where the transport means instanced by the truck travels by using a distance meter and a GPS (Global Positioning System) receiver.

A graph of a relationship between the date/time and the temperature is displayed at a middle part on the right side of the output example in FIG. 9. In FIG. 9, the axis of abscissa indicates the time, and the axis of ordinate indicates the temperature. The temperature used herein is a temperature indicated by a thermometer installed in the transport means instanced by the transport truck. The graph may also display the commodity 300 exhibiting the occurrence of abnormality, and display a commodity number and a symbol indicating the abnormality in association with the date/time when the abnormality occurs.

Displayed in a card format at a lower part on the right side of the output example in FIG. 9 are a measurement target number of commodities 300 and the colors of the thermo-paints coated over the packages of the commodities 300 at a shipping time; and the measurement target number of commodities 300 and the colors of the thermo-paints coated over the packages of the commodities 300 at an arrival time. Colors different from the color of the thermo-paint may be displayed at card-formatted outer frames in the way of displaying in green the commodity delivered in a state of the predetermined temperature and receivable without any problem in quality, and by contrast displaying the commodity with the problem in quality in red.

The output unit 140 may be equipped with a printer for printing a temperature management state in a report format in place of the display or together with the display.

The operation in the information processing apparatus 100 may also be performed by another information processing apparatus instanced by the server connected to the information processing apparatus 100 connected via the network and other equivalent communication infrastructures.

The camera 200 captures the image of the thermo-paint coated corresponding to the temperature management target commodity 300. The camera 200 captures the image of the thermo-paint at an interval of, e.g., predetermined time. The camera 200 may also capture the image of the thermo-paint, based on an instruction given form the information processing apparatus 100. The camera 200 transmits the captured image to the information processing apparatus 100.

The commodities 300 are exemplified by foods, materials, precision instruments, and animals/plants, which are required to be managed in terms of the temperature. The commodities 300 are not limited to these items. As described above, the thermo-paint is coated over the surface of the commodity 300 or the surface of the package of the commodity 300. The card, the seal and other equivalent materials each coated with the thermo-paint may also be attached to the commodity 300 or the package of the commodity 300. The thermo-paint exists in a position that is visually recognizable from outside. Pieces of identifying information for identifying the commodity 300 and the thermo-paint may be written to the periphery of the thermo-paint. The temperature management target commodity 300 is made corresponding to the thermo-paint coated over the package and other equivalent materials.

The information processing apparatus 100 is attainable by using a dedicated or general-purpose computer instanced by a smartphone, a mobile phone, a tablet-type device, a car navigation system a PDA (Personal Digital Assistant) and a workstation (WS), or an electronic equipment mounted with the computer.

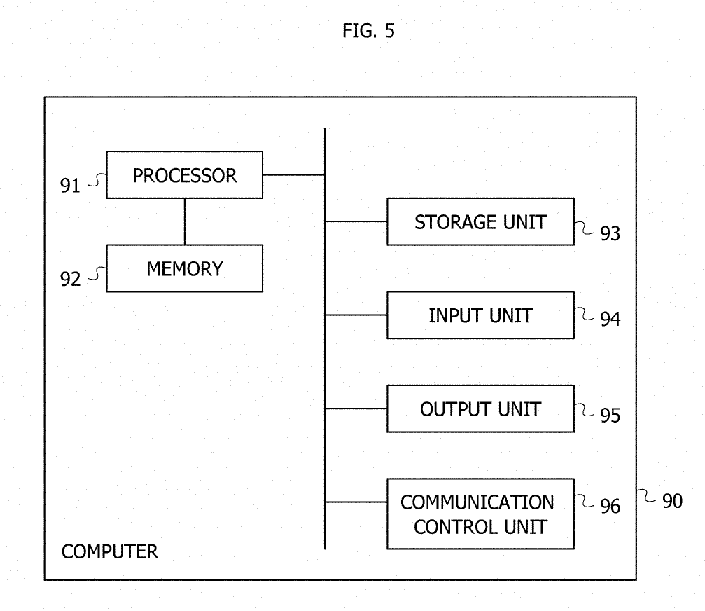

FIG. 5 is a diagram illustrating an example of a hardware configuration of the computer. The computer illustrated in FIG. 5 has a configuration of a general type of computer. The information processing apparatus 100 is attained by a computer 90 as depicted in FIG. 5. The computer 90 in FIG. 5 includes a processor 91, a memory 92, a storage unit 93, an input unit 94, an output unit 95, and a communication control unit 96. The memory 92 is connected directly to the processor 91, and the components other than the memory 92 are interconnected via a bus. The storage unit 93 is a non-transitory computer readable recording medium. The components of the hardware configuration of the computer may be properly omitted, replaced and added without being limited to the configuration illustrated in FIG. 5.

The processor 91 loads programs and various items of data and various types of tables stored on the recording medium onto a work area of the memory 92 and executes these software components, and respective constructive units are controlled through running the programs, whereby the computer 90 can attain functions matching with predetermined purposes.

The processor 91 is instanced by a CPU (Central Processing Unit) and a DSP (Digital Signal Processor).

The memory 92 includes, e.g., a RAM (Random Access Memory) and a ROM (Read Only Memory). The memory 92 is also called a main storage device.

The storage unit 93 is instanced by an EPROM (Erasable Programmable ROM) and a Hard Disk Drive (HDD). The storage unit 93 can include a removable medium, i.e., a portable recording medium. The removable medium is a disk recording medium instanced by a USB (Universal Serial Bus), or a CD (Compact Disc) and a DVD (Digital Versatile Disc). The storage unit 93 is also called a secondary storage device.

The storage unit 93 stores various categories of programs, the various items of data and the various types of tables on the recording medium in a readable/writable manner. An Operating System (OS), the various categories of programs, the various types of tables and other equivalent software components are stored on the storage unit 93. The information stored on the storage unit 93 may also be stored on the memory 92. The information stored on the memory 92 may also be stored on the storage unit 93.

The OS is defined as software acting as an intermediary between software and hardware, and managing a memory space, files, processes and tasks. The OS includes a communication interface. The communication interface is a program for transferring and receiving the data to and from other external apparatuses connected via the communication control unit 96. The external apparatuses encompass, e.g., other computers and external storage devices.

The input unit 94 includes a keyboard, a pointing device, a wireless remote controller, a touch panel and other equivalent devices. The input unit 94 can include a video/picture input device like a camera, and a voice/sound input device like a microphone.

The output unit 95 includes a display device instanced by an LCD (Liquid Crystal Display), an EL (Electroluminescence) panel, a CRT (Cathode Ray Tube) display and a PDP (Plasma Display Panel), and an output device instanced by a printer. The output unit 95 can include a voice/sound output device instanced by a loudspeaker.

The communication control unit 96 connects with other apparatuses, and controls the communications between the computer 90 and other apparatuses. The communication control unit 96 is, e.g., a LAN (Local Area Network) interface board, a wireless communication circuit for wireless communications, and a communication circuit for wired communications. The LAN interface board and the wireless communication circuit are connected to the network instanced by the Internet.

The processor loads the programs stored on the secondary storage device onto the main storage device and runs the programs, whereby the computer configured to attain the information processing apparatus 100 attains functions as respective function units. On the other hand, the storage unit of the information processing apparatus 100 is provided in a storage area of the main storage device or the secondary storage device.

### Operational Example

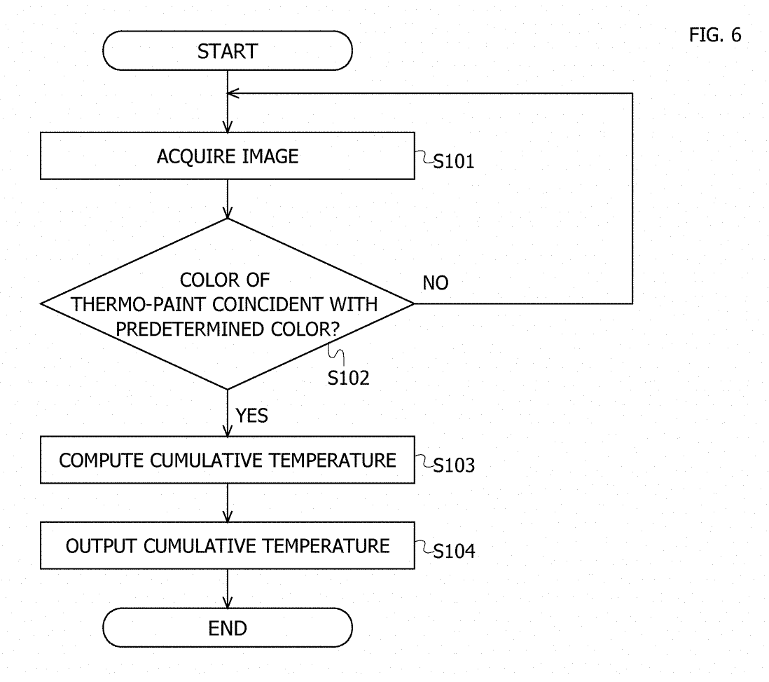

FIG. 6 is a flowchart illustrating an example of an operation flow of a temperature management system according to the embodiment. The camera 200 is connected in a communicable manner to the information processing apparatus 100 of the temperature management system 10. The commodity 300 packed into a packing box coated with the thermo-paint exists in front of the camera 200. The camera 200 is set capable of capturing the image of the thermo-paint. A predetermined illumination may also be used together with the camera 200. The use of the predetermined illumination enables the color of the thermo-paint to be image-captured stably without depending on ambient brightness, an ambient color temperature and other equivalent elements.

In S101, the arithmetic unit 110 of the information processing apparatus 100 instructs, via the communication unit 130, the camera 200 to capture the image of the commodity 300 including a coated area of the thermo-paint. The camera 200 captures the image of the commodity 300 including the coated area of the thermo-paint, based on the instruction given from the information processing apparatus 100. The camera 200 transmits the captured image to the information processing apparatus 100. The arithmetic unit 110 of the information processing apparatus 100 receives the image captured by the camera 200 via the communication unit 130. The arithmetic unit 110 stores the received image on the storage unit 120. The image stored on the storage unit 120 may be associated with an image capturing date/time and other equivalent items. The information processing apparatus 100 may acquire the image captured beforehand by the camera 200. As for the image to be acquired, the information processing apparatus 100 may also acquire a plurality of captured images of a plurality of coating portions of the thermo-paints corresponding to a plurality of commodities 300.

In S102, the arithmetic unit 110 extracts the coating portion of the thermo-paint from the image captured by the camera 200, and determines whether the color of the coating portion is coincident with a predetermined color or not. The arithmetic unit 110 extracts the coating portion of the thermo-paint of the captured image, based on, e.g., the identifying information that specifies the thermo-paint. Information instanced by a graphic symbol, a sign and a character string for identifying the preset thermo-paint may be rendered along the periphery of the thermo-paint. The arithmetic unit 110 recognizes a position of the thermo-paint, and extracts the coating portion of the thermo-paint. When the camera 200 captures the image of the thermo-paint, the arithmetic unit 110 previously determines an area of the coating portion of the thermo-paint in the image, and may extract this area as the coating portion of the thermo-paint.

The arithmetic unit 110 detects a color of the extracted coating portion. The arithmetic unit 110, when the coating portion is not uniform in color, sets an average value of the color of the coating portion as the color of the coating portion. The arithmetic unit 110, when the coating portion is not uniform in color, may detect the color occupying a broadest area as the color of the coating portion. The arithmetic unit 110, when the coating portion is not uniform in color, may also detect the color at a central part of the coating portion as the color of the coating portion. The arithmetic unit 110 stores the detected color of the coating portion in the storage unit 120. Note that the color of the coating portion may also be determined by a median and a mode other than the average value. The arithmetic unit 110 determines whether the detected color of the coating portion is coincident with the color of the thermo-paint that is contained in the data representing the correspondence relationship. When both of the colors are not coincident (S102; NO), the processing loops back to S101, in which the image is again acquired. Whereas when both of the colors are coincident (S102; YES), the processing advances to S103.

In S103, the arithmetic unit 110 computes the cumulative temperature from the detected color of the coating portion. The arithmetic unit 110 computes the cumulative temperature corresponding to the color of the coating portion from the data representing the correspondence relationship between the thermo-paint color and the cumulative temperature, which are stored in the storage unit 120. The arithmetic unit 110 stores the computed cumulative temperature in the storage unit 120.

In S104, the arithmetic unit 110 causes the output unit 140 to display the computed cumulative temperature and other equivalent items. The output unit 140 displays the computed cumulative temperature and other equivalent items toward the user and other equivalent persons of the information on the display and other equivalent devices. The user of the information processing apparatus 100 for managing the temperature of the commodity 300 is able to check the cumulative temperature of the commodity 300. The user checks the cumulative temperature, thereby enabling, e.g., a determination for assuring the quality of the commodity 300 and a determination for disposal of the commodity 300. The arithmetic unit 110 may transmit the computed cumulative temperature to another information processing apparatus instanced by the server via the communication unit 130.

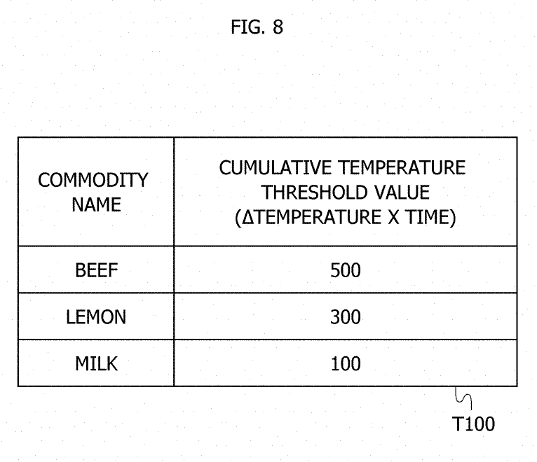

The arithmetic unit 110 can also determine as a proxy for the user whether the commodity 300 is in a quality assured state, based on a management index table T100 illustrated in FIG. 8. The management index table T100 contains descriptions of a commodity name of the commodity 300 and a threshold value of the cumulative temperature of the commodity 300. When the measured cumulative temperature of the commodity 300 exceeds the threshold value of the cumulative temperature, the arithmetic unit 110 determines that the commodity 300 is not in the quality assured state. Based on this result, the user may not accept the commodity 300 with the quality not being assured.

The thermo-paint is to take on the color of the cumulative temperature “0” when starting the measurement of the cumulative temperature. The color of the thermo-paint is image-captured when starting and finishing the measurement of the cumulative temperature, and the cumulative temperature during a period between the start of the measurement and the end of the measurement may also be computed from a difference between the cumulative temperature corresponding to the color when finishing the measurement and the cumulative temperature corresponding to the color when starting the measurement.

### Modified Example

The example described above uses one type of thermo-paint, and two or more types of thermo-paints may, however, be used. Described herein is an example of using the two types of thermo-paints having different reference temperatures. In this case, the operation of the temperature management system. 10 has points common to and different from the example described above. The discussion herein focuses on the different points.

The commodity 300 (or the package of the commodity 300) is to be coated with a first thermo-paint with a first temperature being set set as the reference temperature and a second thermo-paint with a second temperature being higher than the first temperature and set set as the reference temperature. In S101, the camera 200 captures the image of the commodity 300 so as to contain a coating portion of the first thermo-paint and a coating portion of the second thermo-paint. In S102, the arithmetic unit 110 extracts a color of the coating portion of the first thermo-paint and a color of the coating portion of the second thermo-paint from the captured image. In S103, the arithmetic unit 110 computes, based on the color of the first thermo-paint and the color of the second thermo-paint, a cumulative temperature of the first thermo-paint and a cumulative temperature of the second thermo-paint. In S104, the arithmetic unit 110 outputs these cumulative temperatures.

For example, even when enabled to recognize from only the first thermo-paint whether the commodity 300 reaches a temperature equal to or higher than the first temperature, it is difficult to recognize whether the commodity 300 reaches a temperature equal to or higher than the second temperature. However, the use in combination with the second thermo-paint makes it possible to recognize whether the commodity 300 reaches the temperature equal to or higher than the second temperature. The use of the cumulative temperature of the first thermo-paint and the cumulative temperature of the second thermo-paint enables an in-depth recognition by managing a history of the ambient temperatures of the commodity 300, e.g., by managing temperature fluctuations higher and lower than a setting temperature.

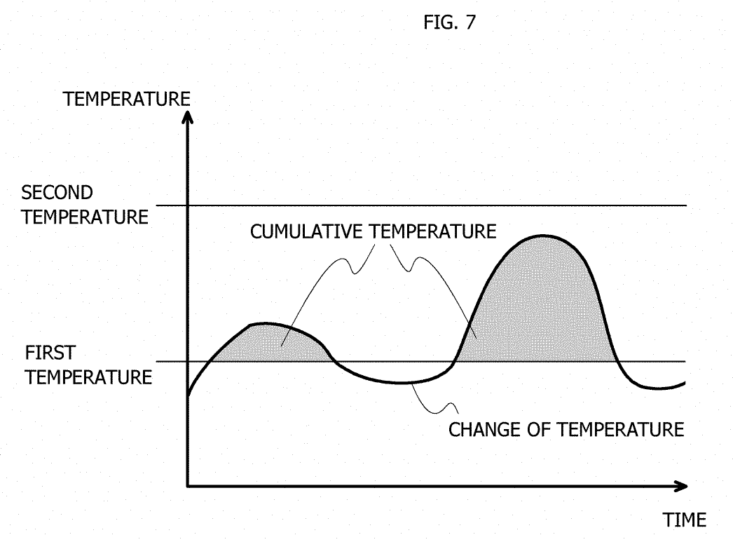

FIG. 7 is a graphic chart illustrating an example of the cumulative temperature. The graph in FIG. 7 indicates an example of the timewise change of the ambient temperature of the thermo-paint. In FIG. 7, the axis of abscissa indicates the time, and the axis of the ordinate indicates the temperature. The first temperature is the reference temperature of the first thermo-paint. The second temperature is the reference temperature of the second thermo-paint. As in the timewise change of the temperature in FIG. 7, the ambient temperature of the thermo-paint changes higher and lower than the first temperature, and, when not reaching the second temperature, the cumulative temperature of the first thermo-paint takes a value larger than “0”, while the cumulative temperature of the second thermo-paint becomes “0”. At this time, the user can recognize that the ambient temperature of the thermo-paint reaches the first temperature but does not reach the second temperature.

When exceeding a cumulative temperature causing saturation of the color of the thermo-paint, it is difficult to recognize cumulative temperatures higher than this color saturation cumulative temperature. When using the thermo-paint having the cumulative temperature as high as causing the color saturation, it is difficult to compute the cumulative temperature as the case may be when the cumulative temperature is low. This is because the thermo-paint having the cumulative temperature as high as causing the color saturation becomes small in color change against the change of the cumulative temperature. At this time, there may be used the two types of thermo-paints exhibiting the same reference temperature but different cumulative temperatures causing the color saturation (the first thermo-paint exhibiting a lower cumulative temperature causing the color saturation, and the second thermo-paint exhibiting a higher cumulative temperature causing the color saturation). Hereat, the cumulative temperature is computed from the color of the first thermo-paint when the cumulative temperature is low, and is computed from the color of the second thermo-paint with respect to the cumulative temperature exceeding the cumulative temperature causing the color saturation of the first thermo-paint. A wide range of cumulative temperatures of the commodity 300 can be thereby computed more accurately.

### Operation and Effect of Embodiment

The temperature management system 10 computes the cumulative temperature from the color of the thermo-paint coated over the commodity 300 or the package of the commodity 300. The cumulative temperature contains information of the temperature difference between the reference temperature and the ambient temperature of the thermo-paint (which is limited to when the ambient temperature exceeds the reference temperature) and information of the time for which to exceed the reference temperature. The temperature management system 10 is capable of managing the temperature of the commodity 300 more simply than when employing the temperature logger and other equivalent devices by using the thermo-paint .

For example, when starting the transport of the commodity 300, the thermo-paint is coated over the [packing box of the commodity 300. The information processing apparatus 100 computes the cumulative temperature of the commodity 300 from the image containing the coating portion of the thermo-paint corresponding to the commodity 300 that is image-captured when completing the transport. The use of the cumulative temperature enables the user to recognize whether over the reference temperature for a long period of time during the transport, and whether the temperature exceeds the reference temperature to a great degree. The quality of the commodity 300 instanced by the food can be maintained in some case even when exceeding the predetermined reference temperature for a short period of time. A fact of exceeding the predetermined reference temperature even slightly is clarified, and hence the commodity 300 instanced by the food with the quality being affected by the temperature is disabled from maintaining the quality in some case. In this instance, the cumulative temperature can be computed by using the temperature management system 10, and it is thereby feasible to determine whether the quality of the commodity 300 can be assured. The use of the cumulative temperature containing the time information enables the quality of the commodity 300 to be determined more accurately. Unnecessary disposals of the commodities 300 can be thereby reduced.

The same is applied to when the thermo-paint changes in color on the basis of the cumulative temperature defined as the product of the temperature difference between the reference temperature and the ambient temperature of the thermo-paint (which is limited to when the ambient temperature is lower than the reference temperature) and the time for which the temperature is lower than the reference temperature. Computed in this case is the cumulative temperature as the product of the temperature difference from the reference temperature given when the ambient temperature of the commodity 300 decreases under the reference temperature and the time for which the temperature is lower than the reference temperature. The use of this thermo-paint also enables the user to recognize whether the commodity is maintained within the predetermined temperature range, and to recognize the cumulative temperature when deviating from the temperature range.

The embodiments discussed above can be carried out by combining the configurations thereof to the greatest possible degree.

<Non-Transitory Computer-Readable Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Components instanced by a CPU, a memory and other equivalent components configuring the computer are provided within the recording medium described above, and the CPU may be made to run the program.

Among these non-transitory recording mediums, the mediums removable from the computer and other equivalent apparatuses are exemplified by a flexible disc, a magneto-optic disc, a CD-ROM, a CD-R/W, a DVD, a DAT, an 8 mm tape, and a memory card.

A hard disc, a ROM (Read-Only Memory) and other equivalent recording mediums are given as the non-transitory recording mediums fixed within the computer and other equivalent apparatuses.

What is claimed is:

1. A temperature management apparatus comprising:
an acquiring unit to acquire an image containing a portion coated with a first thermo-paint with its color changing based on a first cumulative temperature as a product of a temperature difference between a predetermined first temperature and an ambient temperature when the ambient temperature exceeds the first temperature and time for which the ambient temperature exceeds the first temperature;
a storage unit to store first data exhibiting a correspondence relationship between the color of the first thermo-paint and the first cumulative temperature; and
an arithmetic unit to compute the first cumulative temperature corresponding to the color of the first thermo-paint, based on the color of the first thermo-paint contained in the image and the first data,
wherein the first thermo-paint is coated directly or indirectly over a measurement object.

2. The temperature management apparatus according to claim 1, wherein the acquiring unit acquires the image further containing a portion coated with a second thermo-paint with its color changing based on a second cumulative temperature as a product of a temperature difference between a second temperature and the ambient temperature when the ambient temperature exceeds the second temperature higher than the first temperature and time for which the ambient temperature exceeds the second temperature;
the storage unit stores second data representing a correspondence relationship between a color of the second thermo-paint and the second cumulative temperature;
the arithmetic unit computes the second cumulative temperature corresponding to the color of the second thermo-paint, based on the color of the second thermo-paint contained in the image and the second data; and
the second thermo-paint is coated directly or indirectly over the measurement object together with the first thermo-paint.

3. The temperature management apparatus according to claim 1, further comprising a display unit to display any one or more of the image acquired by the acquiring unit, an arithmetic result of the arithmetic unit and information of the measurement object not satisfying a predetermined condition.

4. A temperature management method for executing:
acquiring an image containing a portion coated with a first thermo-paint with its color changing based on a first cumulative temperature as a product of a temperature difference between a predetermined first temperature and an ambient temperature when the ambient temperature exceeds the first temperature and time for which the ambient temperature exceeds the first temperature; and
computing the first cumulative temperature corresponding to the color of the first thermo-paint, based on the color of the first thermo-paint contained in the image and the first data representing a correspondence relationship between the color of the first thermo-paint and the first cumulative temperature,
wherein the first thermo-paint is coated directly or indirectly over a measurement object.

5. The temperature management method according to claim 4, further executing displaying any one or more of the acquired image, an arithmetic result of the computation and information of the measurement object not satisfying a predetermined condition.

6. A non-transitory computer readable medium stored a temperature management program to make a computer execute:
acquiring an image containing a portion coated with a first thermo-paint with its color changing based on a first cumulative temperature as a product of a temperature difference between a predetermined first temperature and an ambient temperature when the ambient temperature exceeds the first temperature and time for which the ambient temperature exceeds the first temperature; and
computing the first cumulative temperature corresponding to the color of the first thermo-paint, based on the color of the first thermo-paint contained in the image and the first data representing a correspondence relationship between the color of the first thermo-paint and the first cumulative temperature,
wherein the first thermo-paint is coated directly or indirectly over a measurement object.
